(19) United States
(12) Patent Application Publication
(10) Pub. No.: US 2026/0054509 A1
(43) Pub. Date: Feb. 26, 2026

(54) SHEET CONVEYING DEVICE AND RECORDING APPARATUS

(71) Applicant: CANON KABUSHIKI KAISHA, Tokyo (JP)

(72) Inventor: Kanto Kurasawa, Tokyo (JP)

(21) Appl. No.: 19/290,592

(22) Filed: Aug. 5, 2025

(30) Foreign Application Priority Data
Aug. 23, 2024 (JP) 2024-141976

(51) Int. Cl. B41J 15/16; B41J 15/04

(52) U.S. Cl. CPC B41J 15/165; B41J 15/048

(57) ABSTRACT

A sheet conveying device includes a holding portion, a first drive unit that rotates the roll sheet, a pair of rollers that hold the sheet therebetween, a second drive unit that rotationally drives the pair of rollers, a dancer roller configured to be linearly movable in a movement direction, a position detecting portion that detects a position of the dancer roller in the movement direction, and a control portion. The control portion performs (i) first control of using the first drive unit to adjust the position of the dancer roller on the basis of a result of the detection by the position detecting portion before using the second drive unit to start the conveyance of the sheet and (ii) second control of using the second drive unit to start the conveyance of the sheet without performing the first control.

### BACKGROUND

### Field of the Technology

The present disclosure relates to a sheet conveying device and a recording apparatus including the sheet conveying device.

### Description of the Related Art

A configuration is known in which, in a sheet conveying device that holds a roll sheet, draws the sheet from the roll sheet, and conveys the sheet, a dancer roller is provided in a movable state to come into contact with the sheet and absorb slack in the sheet.

Japanese Patent Application Publication No. 2022-083640 discloses a configuration in which, in a recording apparatus (printing apparatus) including a dancer roller, to prevent bottom-out (bottoming) of the dancer roller, conveyance of a sheet is started in a state where a sheet conveyance speed is set lower than a target speed in a predetermined case.

However, when the conveyance speed is set lower at the start of the conveyance as in the configuration described above, it takes time to reach the target conveyance speed. In addition, when the conveyance speed is not sufficiently lowered, it may be possible that the bottom-out of the dancer roller cannot be prevented.

### SUMMARY

Present disclosure is directed to provide a sheet conveying device that prevents destabilized sheet conveyance.

According to some embodiments, a sheet conveying device of the present disclosure is characterized by features including:
a holding portion configured to hold a roll sheet in which a sheet is wound;
a first drive unit configured to rotate the roll sheet held by the holding portion in a first direction and in a second direction opposite to the first direction;
a pair of rollers configured to hold the sheet continued from the roll sheet held by the holding portion therebetween;
a second drive unit configured to rotationally drives the pair of rollers;
a dancer roller configured to come into contact with the sheet, the dancer roller provided between the holding portion and the pair of rollers in a conveyance direction of the sheet and being configured to be linearly movable in a movement direction crossing the conveyance direction;
a position detecting portion configured to detect a position of the dancer roller in the movement direction; and
a control portion configured to perform (i) first control of using the first drive unit to adjust the position of the dancer roller on the basis of a result of the detection by the position detecting portion before using the second drive unit to start the conveyance of the sheet and (ii) second control of using the second drive unit to start the conveyance of the sheet without performing the first control.

According to the present disclosure, it is possible to provide a sheet conveying device that prevents destabilized sheet conveyance.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a schematic configuration of a recording apparatus according to a first embodiment;

FIG. 2 is a block diagram illustrating a control configuration of the recording apparatus according to the first embodiment;

FIGS. 3A and 3B are illustrative views of a holding configuration of a dancer roller according to the first embodiment;

FIGS. 4A and 4B are diagrams illustrating the dancer roller located at an upper limit position;

FIGS. 5A and 5B are diagrams illustrating the dancer roller located at a lower limit position;

FIG. 6 is a flow chart of a conveyance start sequence according to the first embodiment;

FIG. 7 is a diagram illustrating the dancer roller located at a target position;

FIG. 8 is a diagram illustrating the sheet conveyed at a target speed;

FIG. 9 is a diagram illustrating the dancer roller located at the upper limit position; and

FIG. 10 is a diagram illustrating the dancer roller located at the lower limit position.

### DESCRIPTION OF THE EMBODIMENTS

Hereinafter, a description will be given, with reference to the drawings, of various exemplary embodiments (examples), features, and aspects of the present disclosure. However, the sizes, materials, shapes, their relative arrangements, or the like of constituents described in the embodiments may be appropriately changed according to the configurations, various conditions, or the like of apparatuses to which the disclosure is applied. Therefore, the sizes, materials, shapes, their relative arrangements, or the like of the constituents described in the embodiments do not intend to limit the scope of the disclosure to the following embodiments.

### First Embodiment

A description will be given of a recording apparatus 90 according to the first embodiment of the present disclosure. The recording apparatus 90 is a printing apparatus configured to include a sheet conveying portion (sheet conveying device) that rotatably holds a roll sheet in which the sheet is wound, and conveys the sheet continued from the roll sheet and a recording portion that records an image on the sheet conveyed by the sheet conveying portion.

Note that, in the present specification, “printing” (which may be referred to also as “typed words”, “recording”, or “print”) not only includes formation of significant information such as characters and graphics, but also broadly includes formation of images, figures, patterns, and the like on a recording medium or processing of the medium, regardless of whether information is significant or insignificant and whether or not the information is visualized so as to be visually perceivable by humans.

### Recording Device 90

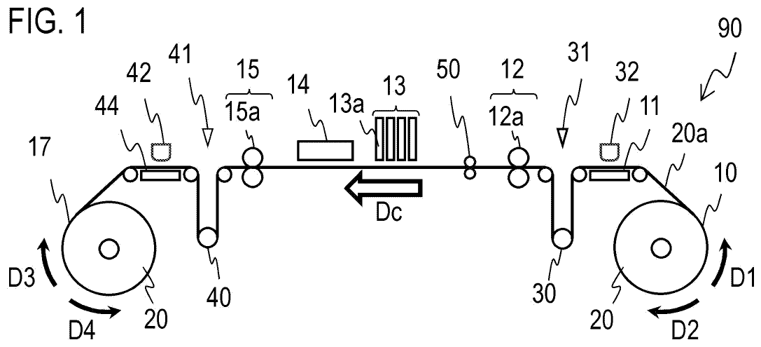

A description will be given of a schematic configuration of the recording apparatus 90. FIG. 1 is a diagram illustrating the schematic configuration of the recording apparatus 90. FIG. 1 illustrates a state where the recording apparatus 90 is in a standby state, as viewed in a direction of a rotation axis of various rollers that convey a sheet 20a drawn from a roll sheet 20. Note that, in the present embodiment, a conveyance direction Dc in which the sheet 20a is conveyed is a direction crossing (perpendicular to) the rotation axis direction of the various rollers, while a width direction of the sheet 20a is a direction parallel to the rotation axis direction of the various rollers.

Note that FIG. 1 is a schematic diagram illustrating only main components. The recording apparatus 90 as a real apparatus can be configured such that, for example, the sheet 20a is conveyed from right to left in FIG. 1 while an image is recorded thereon, is conveyed in a downward direction, is conveyed from left to right in FIG. 1 while being subjected to drying and cooling, is further conveyed in the downward direction, and is conveyed from right to left in FIG. 1. Thus, in FIG. 1, a conveyance route of the sheet 20a in the recording apparatus 90 is drawn so as to linearly extend substantially from right to left, but the conveyance route of the sheet 20a may also be configured so as to draw a large letter-S shape.

In the recording apparatus 90, along the conveyance route of the sheet 20a, a feeding portion 10 (paper feeding portion), a main conveying portion 12, a recording portion 13, a fixing portion 14, a sub-conveying portion 15, and a winding portion 17 are provided in order from an upstream side to a downstream side in the conveyance direction Dc of the sheet 20a during a recording operation.

The feeding portion 10 is a paper feeding device that rotatably holds the roll sheet 20 in which the sheet 20a is wound. The feeding portion 10 is configured to include a holding portion that holds the roll sheet 20 and a drive source (drive unit) that rotates the roll sheet 20 held by the holding portion in a first direction D1 and in a second direction D2 opposite to the first direction D1. The first direction D1 is a feeding direction (unwinding direction) in which the sheet 20a is fed out in the conveyance direction Dc. The second direction D2 is a winding direction in which the sheet 20a is fed out in a direction opposite to the conveyance direction Dc so as to be wound up. In other words, the feeding portion 10 is rotatably configured so as to rotationally drive the roll sheet 20 in the first direction D1 and in the second direction D2.

The winding portion 17 is a winding device that rotatably holds the roll sheet 20. The winding portion 17 is configured to include a holding portion that holds the roll sheet 20 and a drive source (drive unit) that rotates the roll sheet 20 held by the holding portion in a third direction D3 and in a fourth direction D4 opposite to the third direction D3. The third direction D3 is a feeding direction (unwinding direction) in which the sheet 20a is fed out in a direction opposite to the conveyance direction Dc. The fourth direction D4 is a winding direction in which the sheet 20a is fed out in the conveyance direction Dc so as to be wound up. In other words, the winding portion 17 is rotatably configured so as to rotationally drive the roll sheet 20 in the third direction D3 and in the fourth direction D4.

For the sake of convenience, the feeding portion 10 and the winding portion 17 are referred to as such according to operations thereof performed on the sheet 20a during the recording operation. However, as described above, in the first embodiment, the feeding portion 10 can also perform an operation of winding the sheet 20a, and the winding portion 17 can also perform an operation of feeding the sheet 20a. In other words, the recording apparatus 90 includes the feeding portion 10 (first holding portion) and the winding portion 17 (second holding portion) each as a holding portion that rotatably holds the roll sheet in both directions.

The main conveying portion 12 has a pair of rollers 12a capable of conveying the sheet 20a, while holding the sheet 20a therebetween, and the sub-conveying portion 15 has a pair of rollers 15a capable of conveying the sheet 20a, while holding the sheet 20a therebetween. By rotation of the pairs of rollers 12a and 15a included in the main conveying portion 12 and the sub-conveying portion 15, the sheet 20a is conveyed in the conveyance direction Dc so as to pass through the recording portion 13 and the fixing portion 14. Thus, the recording apparatus 90 includes a first pair of rollers provided in the main conveying portion 12 and a second pair of rollers provided in the sub-conveying portion 15. The pairs of rollers 12a and 15a are rotationally driven by the respective drive unit not shown. In other words, the recording apparatus 90 is provided with a first drive unit that rotationally drives the roll sheet 20 in the feeding portion 10, a second drive unit that rotationally drives the pair of rollers 12a, a third drive unit that rotationally drives the roll sheet 20 in the winding portion 17, and a fourth drive unit that rotationally drives the pair of rollers 15a. Note that the first drive unit and the third drive unit are differently numbered for the sake of convenience, but are substantially the same in a sense that the first drive unit and the third drive unit are drive unit that rotationally drive the held roll sheet 20. The same applies also to a relationship between the second drive unit and the fourth drive unit. Each of these drive unit (drive sources) is drive-controlled by a control portion.

The recording portion 13 has a plurality of heads 13a each as a recording head (liquid ejection head) that records an image on the sheet by ejecting a liquid such as ink toward the sheet 20a. FIG. 1 illustrates a configuration in which the four heads 13a are provided by way of example, but a configuration of the recording portion 13 is not limited thereto. In the present embodiment, the respective heads 13a correspond to inks in different colors, and the recording operation is performed by the individual heads 13a by ejecting the inks in the different colors toward the sheet 20a.

The fixing portion 14 is disposed on the downstream side of the recording portion 13 in the conveyance direction Dc, and is provided so as to fix the image recorded on the sheet. The fixing portion 14 can be configured to include, e.g., a drying portion (heating portion) that dries the inks given onto the sheet and a cooling portion that cools the sheet 20a warmed by the drying portion.

The recording apparatus 90 includes a dancer roller 30 as a first dancer roller and a dancer roller 40 as a second dancer roller. The dancer roller 30 is a roller configured to be linearly movable in a movement direction (which is a vertical direction in the present example) crossing the conveyance direction Dc between the feeding portion 10 and the main conveying portion 12 in the conveyance direction Dc and come into contact with the sheet. The dancer roller 40 is a roller configured to be linearly movable in the movement direction (which is the vertical direction in the present example) crossing the conveyance direction Dc between the winding portion 17 and the sub-conveying portion 15 in the conveyance direction Dc and come into contact with the sheet. The dancer rollers 30 and 40 are rotatable slack absorbing members provided to absorb slack in the sheet 20a, which are supported to be liftable according to an amount of the slack in the sheet 20a.

To the dancer rollers 30 and 40, respective tensioning mechanisms not shown apply forces in the downward direction (direction in which tension is applied to the sheet 20a). Examples of the tensioning mechanisms include an air cylinder. The recording apparatus 90 also includes a roller position sensor 31 as a first position detecting portion capable of detecting a position of the dancer roller 30 in a movable direction and a roller position sensor 41 as a second position detecting portion capable of detecting a position of the dancer roller 40 in the movable direction. The roller position sensors 31 and 41 are provided to be able to sense the positions of the roller position sensors 31 and 41 in the movable directions.

On the downstream side of the feeding portion 10 in the conveyance direction Dc and on the upstream side of the dancer roller 30 in the conveyance direction Dc, a splice table 11 and a sheet nip portion 32 are provided. A user can fix the sheet 20a drawn from the roll sheet 20 attached to the feeding portion 10 with the splice table 11 and the sheet nip portion 32. Then, the user can cut the sheet 20a on the splice table 11, replace the roll sheet 20 in the feeding portion 10, and join a leading end of the sheet 20a drawn from the new roll sheet 20 to a rear end of the sheet 20a cut on the splice table 11. Thus, the recording apparatus 90 is configured to be able to replace the roll sheet 20 by merely replacing the roll sheet 20 with a new one in the feeding portion 10 and passing the sheet 20a from the feeding portion 10 to a position of the splice table 11.

On the downstream side of the main conveying portion 12 in the conveyance direction Dc and on the upstream side of the recording portion 13 in the conveyance direction Dc, a meandering correcting portion 50 for correcting meandering of the sheet 20a is provided. The meandering correcting portion 50 is a meandering correcting device for correcting a position of the sheet 20a in the width direction during the conveyance thereof.

On the upstream side of the winding portion 17 in the conveyance direction Dc and on the downstream side of the dancer roller 40 in the conveyance direction Dc, a sheet nip portion 42 and a nip table 44 are provided. The sheet 20a cooled in the fixing portion 14 and having passed through the sub-conveying portion 15 passes through a gap between the sheet nip portion 42 and the nip table 44 until the sheet 20a is wound by the winding portion 17. When removing the roll sheet 20, in which a deliverable is rolled, from the winding portion 17, the roll sheet 20 can be removed from the winding portion 17 by fixing the sheet 20a with the sheet nip portion 42 and the nip table 44 and cutting the sheet 20a between the fixing portion and the winding portion 17. Then, a paper tube is attached to the winding portion 17, and a cut portion of the sheet 20a is attached to the paper tube with a splice tape, thus completing preparation for subsequent winding.

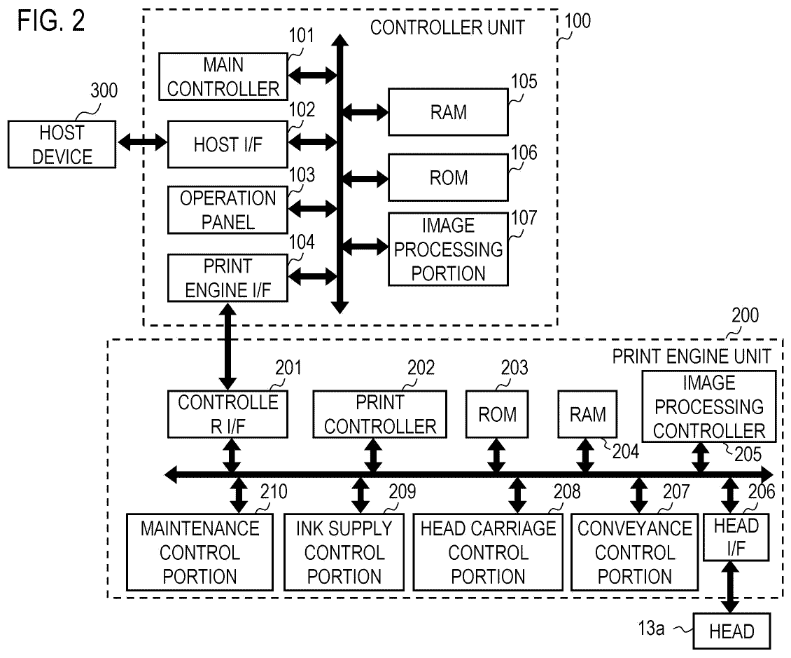

FIG. 2 is a block diagram illustrating a control configuration of the recording apparatus 90. The control configuration is configured to include a print engine unit 200 that is mainly in charge of a print engine and a controller unit 100 that is mainly in charge of the entire recording apparatus 90. A print controller 202 controls various mechanisms of the print engine unit 200 according to an instruction from a main controller 101 of the controller unit 100. A description will be given below of details of the control configuration.

In the controller unit 100, the main controller 101 configured to include a CPU controls the entire recording apparatus, while using a RAM 105 as a work area, according to a program and various parameters each stored in a ROM 106. For example, when a printing job is input from a host device 300 via a host I/F 102, predetermined image processing is performed on image data received by an image processing portion 107 according to an instruction from the main controller 101. Then, the main controller 101 transmits the image data on which the image processing has been performed to the print engine unit 200 via a print engine I/F 104.

Note that the recording apparatus 90 may also acquire image data from an external storage apparatus (such as a USB memory) connected thereto. An operation panel 103 is a mechanism for the user to perform input/output to/from the recording apparatus 90. The user can give an instruction to perform a printing or paper feeding operation via the operation panel 103, set a printing mode, and recognize information on the recording apparatus 90. The operation panel 103 is a touch panel, and it is also possible to perform input thereto by connecting a mouse or a keyboard thereto.

In the print engine unit 200, the print controller 202 configured to include a CPU controls various mechanisms included in the recording apparatus 90, while using a RAM 204 as a work area, according to a program and various parameters each stored in a ROM 203.

When various commands and image data are received via a controller I/F 201, the print controller 202 temporarily stores these in the RAM 204. The print controller 202 causes an image processing controller 205 to convert the stored image data to recording data so as to allow the heads 13a to use the recording data for the recording operation. When the recording data is generated, the print controller 202 causes the headers 13a to perform the recording operation based on the recording data via a head I/F 206. At this time, the print controller 202 drives the feeding portion 10, the main conveying portion 12, the sub-conveying portion 15, and the winding portion 17 each illustrated in FIG. 1 via a conveyance control portion 207 to convey the sheet 20a as a recording medium.

The conveyance control portion 207 is a control portion that can detect an amount of conveyance from an encoder included in a conveying roller. The print controller 202 causes the recording operation to be performed with predetermined timing to thus allow printing processing to be performed. The conveyance control portion 207 independently controls operations of the drive unit (drive sources) that rotationally drive the roll sheet with the feeding portion 10 and the winding portion 17 and the drive unit (motors) that rotationally drive the pair of rollers 12a and the pair of rollers 15a.

In the recording portion 13, the heads 13a are configured to be vertically movable. When performing the recording operation, the heads 13a are located at lowered recording positions, as illustrated in FIG. 1, but can move to raised positions from the recording positions during maintenance or the like. A head carriage control portion 208 changes vertical positions of the heads 13a according to an operating state of the recording apparatus 90, such as a maintenance state or a recording state.

An ink supply control portion 209 controls ink supply units such that pressures of the inks to be supplied to the heads 13a fall within an appropriate range. When performing a maintenance operation on the heads 13a, a maintenance control portion 210 moves the maintenance units to beneath the raised heads to control the maintenance operation on the heads 13a, such as capping or wiping.

### Dancer Rollers

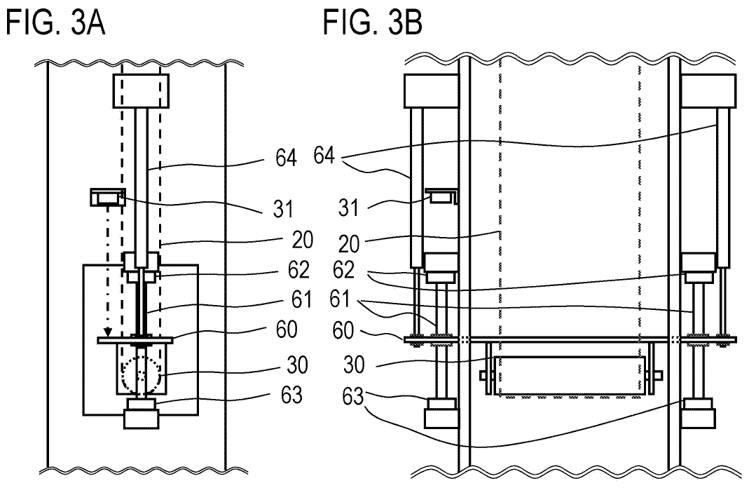

Next, a detailed description will be given of a holding configuration of the dancer roller 30. FIGS. 3A and 3B are illustrative views of the holding configuration of the dancer roller 30 according to the first embodiment. FIG. 3A is a diagram obtained by viewing the dancer roller 30 and the holding configuration thereof in a direction of a rotation axis of the dancer roller 30. FIG. 3B is a diagram obtained by viewing the dander roller 30 and the holding configuration thereof in the direction perpendicular to the rotation axis direction of the dancer roller 30. In FIGS. 3A and 3B, an outline of the sheet 20a in which slack has been absorbed by the dancer roller 30 is indicated by a dotted line.

The recording apparatus 90 includes a dancer roller holding portion 60 that rotatably holds the dancer roller 30. The dancer roller holding portion 60 is configured to be movable (liftable) integrally with the dancer roller 30 in a perpendicular direction with respect to an apparatus main body (housing) of the recording apparatus 90. To the dancer roller holding portion 60, a sliding shaft 61 provided on both sides of a region through which the sheet 20a passes is attached. The sliding shaft 61 is a shaft extending in the vertical direction (gravity direction), and the dancer roller holding portion 60 is configured to include a shaft attachment portion slidably attached to the sliding shaft 61 and a roller holding portion connected to the shaft attachment portion to rotatably hold the dancer roller 30.

A movable range of the dancer roller holding portion 60 and the dancer roller 30 is defined by an upper-limit abutting member 62 and a lower-limit abutting member 63. The upper-limit abutting member 62 is a defining member attached to an upper end portion of the sliding shaft 61, while the lower-limit abutting member 63 is a defining member attached to a lower end portion of the sliding shaft 61. A position where the dancer roller holding portion 60 comes into contact with the upper-limit abutting member 62 corresponds to an upper limit of the movable range of the dancer roller 30, while a position where the dancer roller holding portion 60 comes into contact with the lower-limit abutting member 63 corresponds to a lower limit of the movable range of the dancer roller 30.

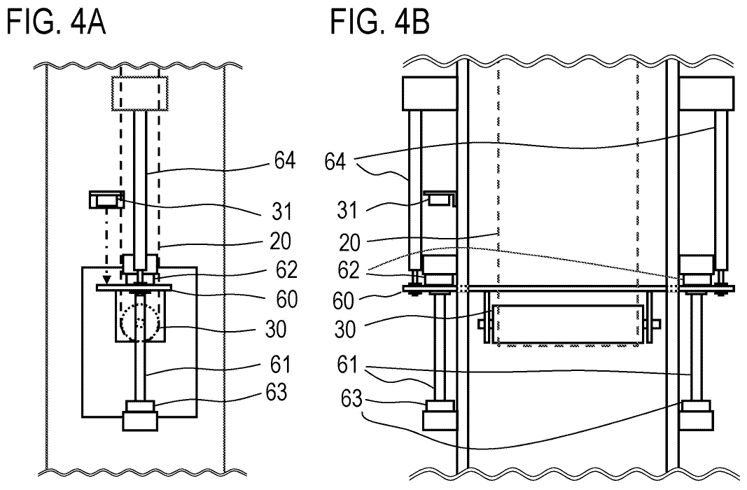

FIGS. 4A and 4B are diagrams illustrating the dancer roller 30 located at an upper limit position of the movable range. FIG. 4A is a diagram obtained by viewing the dancer roller 30 and the holding configuration thereof in the rotation axis direction of the dancer roller 30. FIG. 4B is a diagram obtained by viewing the dancer roller 30 and the holding configuration thereof in the direction perpendicular to the rotation axis direction of the dancer roller 30. At this time, a portion of the dancer roller holding portion 60 is in contact with the upper-limit abutting member 62.

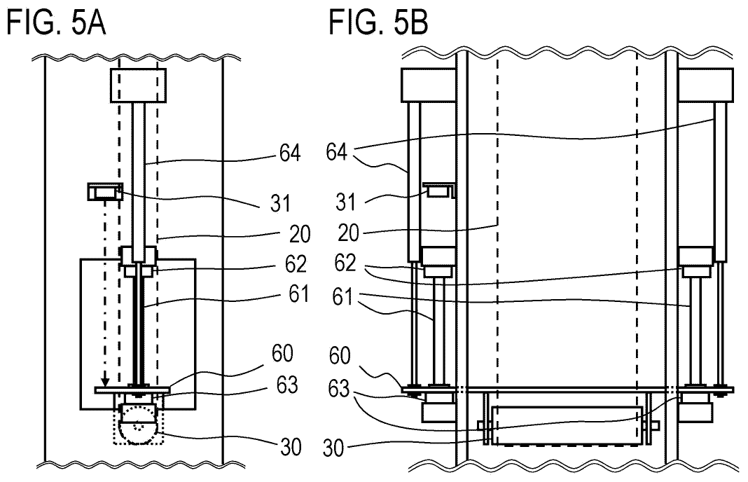

FIGS. 5A and 5B are diagrams illustrating the dancer roller 30 located at a lower limit position of the movable range. FIG. 5A is a diagram obtained by viewing the dancer roller 30 and the holding configuration thereof in the rotation axis direction of the dancer roller 30. FIG. 5B is a diagram obtained by viewing the dancer roller 30 and the holding configuration thereof in the direction perpendicular to the rotation axis direction of the dancer roller 30. At this time, a portion of the dancer roller holding portion 60 is in contact with the lower-limit abutting member 63.

The recording apparatus 90 further includes the roller position sensor 31 as a position detecting portion capable of sensing the position of the dancer roller 30. The roller position sensor 31 according to the first embodiment is a laser distance sensor, and measures a distance to a predetermined position on the dancer roller holding portion 60 with a laser. It is possible to calculate a position of the movable range of the dancer roller 30 from an attachment position of the roller position sensor 31, an inclination between a laser optical axis and the sliding shaft 61, and a result of the measurement.

The recording apparatus 90 includes an air cylinder 64 as a biasing portion that biases the dancer roller holding portion 60 in the downward direction. The air cylinder 64 biases the dancer roller 30 in the downward direction via the dancer roller holding portion 60 with an air pressure. By the biasing force of the air cylinder 64, tension is applied to the sheet 20a wound around the dancer roller 30. Such a configuration moves the dancer roller 30 upward and downward within the movable range to maintain the tension of the sheet 20a constant and prevents slack in the sheet 20a.

Note that a holding configuration of the dancer roller 40 is the same as the holding configuration of the dancer roller 30, and is therefore a description thereof is omitted. The following description will be given by basically using the dancer roller 30 but, in the dancer roller 40 also, the same configuration and operation are implemented.

As described above, the dancer roller 30 has the limited movable range. Accordingly, when the dancer roller 30 is located in the vicinity of the upper limit or the vicinity of the lower limit of the movable range, the position of the dancer roller 30 is preferably adjusted as appropriate. As position adjustment control for the dancer roller 30, feedback control such as, e.g., PID control using position information of the dancer roller 30 acquired by the roller position sensor 31 can be considered.

However, when the sheet conveyance is started in a state where, e.g., the dancer roller 30 is located in the vicinity of the upper limit of the movable range of the dancer roller 30, even when the feedback control is performed, the dancer roller 30 may move beyond the upper limit position particularly immediately after the start of the sheet conveyance. In addition, in a state where the dancer roller 30 is located in the vicinity of the lower limit of the movable range, even when the feedback control is performed by the sheet conveyance, the dancer roller 30 may move beyond the lower limit. Hereinbelow, an attempt by the dancer roller 30 to move beyond the upper limit of the movable range is referred to as top-out, while an attempt by the dancer roller 30 to move beyond the lower limit thereof is referred to as bottom-out. The top-out or bottom-out of the dancer roller 30 may be caused by a factor such as a conveyance speed difference between the main conveying portion 12 and the feeding portion 10.

The top-out or bottom-out of the dancer roller 30 may result in destabilized conveyance of the sheet 20a or fracture of the sheet 20a under excessive tension. Accordingly, the recording apparatus 90 according to the first embodiment is configured to be able to perform processing for preventing the top-out or bottom-out of the dancer roller 30 in a conveyance start sequence in which the conveyance of the sheet 20a is started.

### Conveyance Start Sequence

A description will be given of the conveyance start sequence of the recording apparatus 90. The conveyance start sequence is a sequence for conveying the sheet 20a drawn from the roll sheet 20 at a target speed. Hereinbelow, for the conveyance route for the sheet 20a, a section between the feeding portion 10 and the main conveying portion 12, a section between the main conveying portion 12 and the sub-conveying portion 15, and a section between the sub-conveying portion 15 and the winding portion 17 each in the conveyance direction De are referred to as a feeding section (paper feeding section), a main conveyance section, and a winding section (paper discharge section).

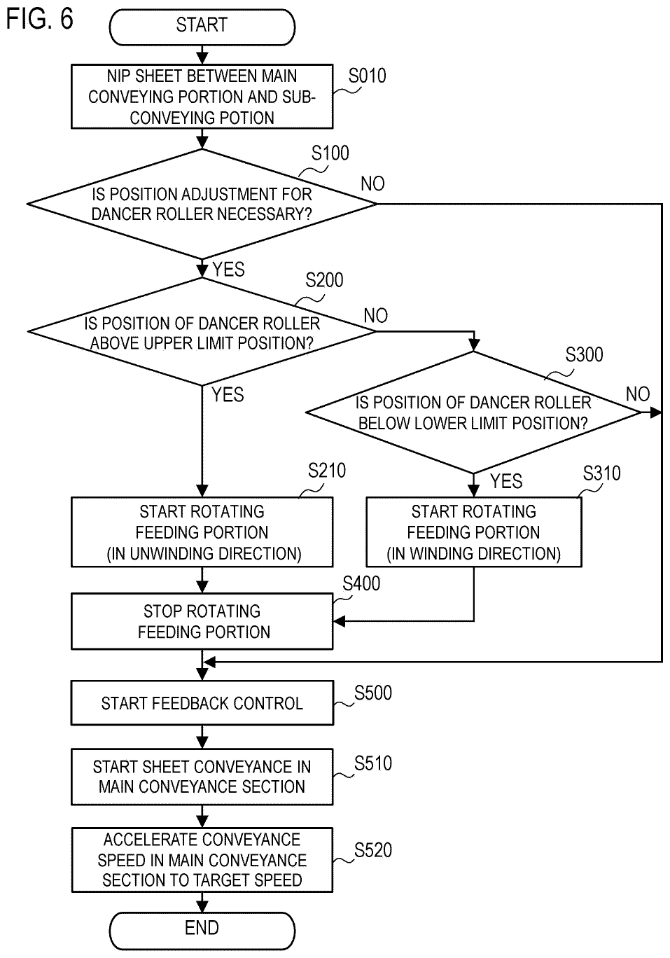

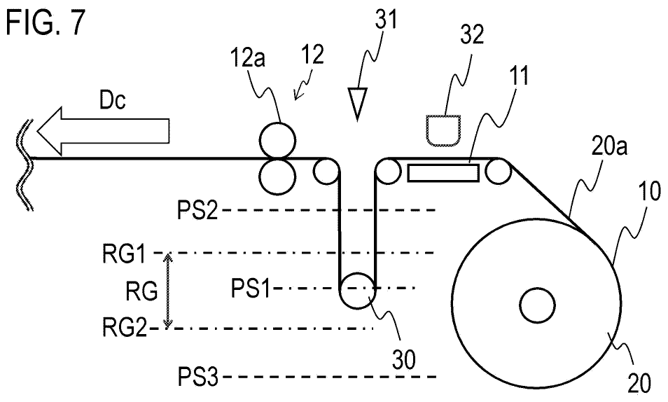

FIG. 6 is a flow chart of the conveyance start sequence according to the first embodiment. FIGS. 7 to 10 are illustrative views of the conveyance start sequence, which illustrates a configuration of the feeding section. In the first embodiment, the conveyance start sequence includes first control of adjusting the position of the dancer roller 30 before the conveyance of the sheet 20a is started in the main conveyance section and second control of starting the conveyance of the sheet 20a in the main conveyance section.

When the conveyance start sequence is started, first, in Step (hereinafter referred to as S) 010, the conveyance control portion 207 nips the sheet 20a between the main conveying portion 12 and the sub-conveying portion 15, and energizes the motor. As a result, the sheet 20a located in the main conveyance section is fixed.

Next, in S100, the conveyance control portion 207 performs position adjustment determination for determining whether or not preliminary position adjustment for the dancer roller 30 is necessary. Since the slack in the sheet 20a in the feeding section varies depending on the position of the dancer roller 30, the position adjustment determination is synonymous to slack adjustment determination for determining whether or not the slack in the sheet 20a is appropriate.

In the first embodiment, the position adjustment determination is performed on the basis of the position information of the dancer roller 30 acquired by the roller position sensor 31. When the dancer roller 30 is located within a default target range RG, the conveyance control portion 207 determines that position adjustment (slack adjustment) is unnecessary (NO in S100) and, otherwise, the conveyance control portion 207 determines that the position adjustment (slack adjustment) is necessary (YES in S100). When determining that the position adjustment is necessary, the conveyance control portion 207 performs the first control of adjusting the position of the dancer roller 30 and, when determining that the position adjustment is unnecessary, the conveyance control portion 207 drives the main conveying portion 12 and the sub-conveying portion 15 to perform the second control of conveying the sheet 20a without performing the first control.

The target range RG to be used for the position adjustment determination is a predetermined range between a range upper limit RG1 and a range lower limit RG2 each determined in advance. In the first embodiment, a target position PS1 of the dancer roller 30 corresponds to a center position of the target range RG. The target position PS1 is a middle (middle position) between a physical upper limit (upper limit position PS2) and a physical lower limit (lower limit position PS3) of the movable range of the dancer roller 30. In other words, in the first embodiment, the conveyance control portion 207 determines that the position adjustment is necessary when the dancer roller 30 is apart from a predetermined reference position (target position PS1) by a predetermined distance or more. Note that a method of setting the target range RG (the range upper limit RG1 and the range lower limit RG2) and the target position PS1 is not limited thereto. For example, the target position PS1 need not be the center position of the target range RG.

First, a description will be given of a case where the second control is to be performed. FIG. 7 is a diagram obtained by viewing the dancer roller 30 located at the target position PS1, i.e., within the target range RG in the rotation axis direction of the dancer roller 30 or the roll sheet 20. When the dancer roller 30 is located at a position illustrated in FIG. 7 in a state where the conveyance start sequence is started, it is determined in S100 that the position adjustment is unnecessary. When it is determined that the position adjustment is unnecessary in S100, a sequence flow moves to S500 to perform the second control.

In S500, the conveyance control portion 207 starts feedback control of driving the feeding portion 10 so as to move the dancer roller 30 to the target position PS1. At this time, the conveyance control portion 207 drives the feeding portion 10 by the feedback control (e.g., the PID control) using the position information of the dancer roller 30 acquired by the roller position sensor 31. The feedback control is performed, while causing the main conveying portion 12 and the sub-conveying portion 15 to convey the sheet 20a.

Next, in S510, the conveyance control portion 207 starts rotating the main conveying portion 12 and the sub-conveying portion 15 to start conveying the sheet 20a in the main conveyance section. At this time, the feeding portion 10 rotates in the first direction D1 in which the sheet 20a is fed in the conveyance direction Dc, while the pair of rollers 12a of the main conveying portion 12 and the pair of roller 15a of the sub-conveying portion 15 also rotate in a direction in which the sheet 20a is conveyed in the conveyance direction Dc.

When the conveyance of the sheet 20a is started in the main conveyance section, the tension applied to the sheet 20a increases, and accordingly the dancer roller 30 moves in a direction (upward direction in FIG. 7) in which a buffer (distance to the upper limit position PS2) decreases. However, by the feedback control of the feeding portion 10, an amount of unwinding (amount of feeding) of the roll sheet 20 is controlled, and consequently the dancer roller 30 remains in the vicinity of the target position. At this time, the conveyance control portion 207 controls the feeding portion 10 independently of the main conveying portion 12 and the sub-conveying portion 15. Thus, when an initial buffer of the dancer roller 30 is optimal, i.e., the position of the dancer roller 30 is in the vicinity of the target position PS1, the conveyance control portion 207 can start conveying the sheet 20a without preliminarily adjusting the position of the dancer roller 30. Then, while the sheet 20a is conveyed, the position of the dancer roller 30 is appropriately adjusted by the feedback control.

Then, in S520, the conveyance speeds of the main conveying portion 12 and the sub-conveying portion 15 are accelerated to target speeds. When the acceleration of the conveying speeds to the target speeds is ended, the conveyance start sequence is ended, and the sheet 20a is continuously conveyed at the target speed. By such a configuration, the speed of the conveyance of the sheet 20a by the feeding portion 10 is appropriately adjusted such that the dancer roller 30 is located at the target position PS1, while the main conveying portion 12 and the sub-conveying portion 15 convey the sheet 20a at the target speeds.

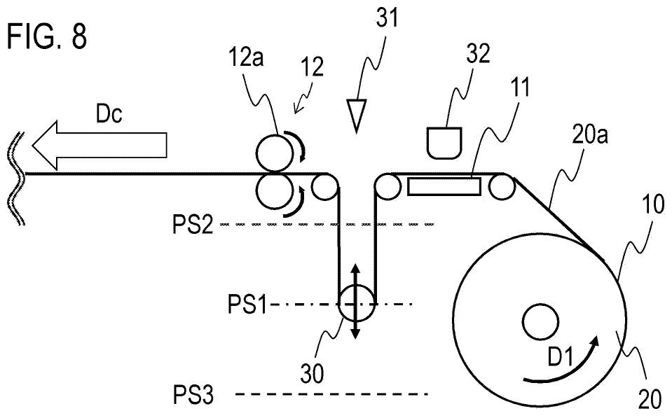

FIG. 8 is a diagram obtained by viewing the sheet 20a conveyed at the target speed in the rotation axis direction of the dancer roller 30 or the roll sheet 20. The dancer roller 30 moved to the target position PS1 in S500 moves upward and downward during the conveyance of the sheet 20a to prevent slack in the sheet 20a. Thus, under the second control, the main conveying portion 12 and the sub-conveying portion 15 are driven by the drive unit to start conveying the sheet 20a without the preliminary position adjustment performed for the dancer roller 30. Then, during the conveyance of the sheet 20a, the control (feedback control) of keeping the position of the dancer roller 30 within the target range RG is performed.

Next, a description will be given of a case where the first control is to be performed. When it is determined in S100 that the dancer roller 30 is located outside the target range RG and the position adjustment is necessary, the sequence flow moves to S200. In S200, the conveyance control portion 207 determines whether or not the position of the dancer roller 30 is above the range upper limit RG1 (on the upper limit position PS2 side) on the basis of the position information of the dancer roller 30 acquired by the roller position sensor 31. When the dancer roller 30 is located above the range upper limit RG1, i.e., when YES is given in S200, the sequence flow advances to S210. Meanwhile, when the dancer roller 30 is located at the range upper limit RG1 or therebelow, i.e., when NO is given in S200, the sequence flow advances to S300.

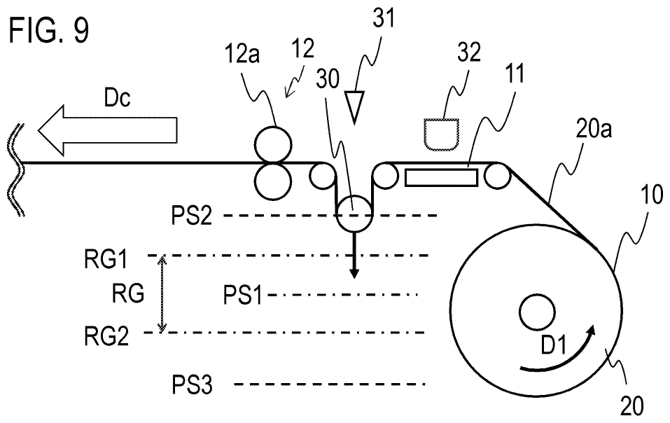

FIG. 9 is a diagram illustrating the dancer roller 30 located at the upper limit position PS2, i.e., above the range upper limit RG1. At this time, between the feeding portion 10 and the main conveying portion 12, the sheet 20a has no slack and is tightly wound and, due to the tension of the sheet 20a, the dancer roller 30 is in a state raised to the upper limit position PS2. In such a case, YES is given in S200.

After YES is given as a result of the determination made in S200, in S210, the feeding portion 10 starts rotating at a given speed in the first direction D1 (unwinding direction). At this time, in a state where the pairs of rollers 12a and 15a are controlled to stop rotating, the feeding portion 10 rotates in the first direction D1. By the rotation of the feeding portion 10 in the first direction D1, the sheet 20a is drawn from the roll sheet 20 held by the feeding portion 10, the tension related to the dancer roller 30 is reduced, and the dancer roller 30 lowers. In other words, S210 is a step of a position adjustment operation which is performed by the pairs of rollers 12a and 15a for the dancer roller 30 before the conveyance of the sheet 20a by the pairs of rollers 12a and 15a is started. This position adjustment operation is performed in a state where the pairs of rollers 12a and 15a are not rotated.

After the rotation is started in S210, in S400, the conveyance control portion 207 stops the rotation of the feeding portion 10 such that the moving dancer roller 30 stops at the target position PS1, and the preliminary position adjustment operation is ended. In other words, the dancer roller 30 in a state as illustrated in FIG. 9 is shifted to a state as illustrated in FIG. 7 by the driving of the feeding portion 10 in S210 and S400. After the adjustment of the position of the dancer roller 30 in S210 and S400, the sequence flow advances to S500 and, after process steps in S510 and S520, the conveyance start sequence is ended, and the sheet 20a continues to be conveyed at the target speed.

After “NO” is given as a result of the determination made in S200, in S300, the conveyance control portion 207 determines whether or not the position of the dancer roller 30 is located below the range lower limit RG2 (on the lower limit position PS3 side) on the basis of the position information of the dancer roller 30 acquired by the roller position sensor 31. When the dancer roller 30 is located below the range lower limit RG2, i.e., when YES is given in S300, the sequence flow advances to S310. Meanwhile, when the dancer roller 30 is located at the range lower limit RG2 or thereabove, i.e., when NO is given in S300, the sequence flow advances to S500.

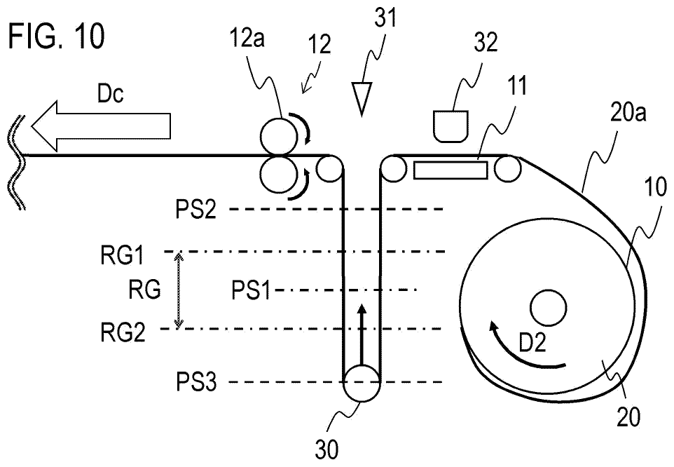

FIG. 10 is a diagram illustrating the dancer roller 30 located at the lower limit position PS3, i.e., below the range lower limit RG2. At this time, between the feeding portion 10 and the main conveying portion 12, the sheet 20a has slack and, under the biasing force of the air cylinder 64, the dancer roller 30 is in a state depressed to the lower limit position PS3. In such a case, NO is given in S200, and YES is given in S300.

When YES is given as a result of the determination made in S300, in S310, the feeding portion 10 starts rotating at a given speed in the second direction D2 (winding direction). At this time, in a state where the pairs of rollers 12a and 15a are controlled to stop rotating, the feeding portion 10 rotates in the second direction D2. By the rotation of the feeding portion 10 in the second direction D2, the roll sheet 20 held by the feeding portion 10 winds up the sheet 20a, and the tension applied to the dancer roller 30 increases to lift the dancer roller 30. In other words, similarly to S210, S310 is a step of the position adjustment operation performed for the dancer roller 30 before the start of the conveyance of the sheet 20a.

After the rotation is started in S310, in S400, the conveyance control portion 207 stops the rotation of the feeding portion 10 such that the moving dancer roller 30 stops at the target position PS1. In other words, the dancer roller 30 in such a state as illustrated in FIG. 10 is shifted to such a state as illustrated in FIG. 7 by the driving of the feeding portion 10 in S310 and S400. After the adjustment of the position of the dancer roller 30 in S310 and S400, the sequence flow advances to S500 and, after process steps in S510 and S520, the conveyance start sequence is ended, and the sheet 20a continues to be conveyed at the target speed.

Meanwhile, after NO is given as a result of the determination made in S300, the sequence flow advances to S500. In other words, it is determined that the preliminary position adjustment for the dancer roller 30 is unnecessary, and the feedback control is started. A case where the sequence flow advances from S300 to S500 is also included in the second control. Note that, in the first embodiment, when YES is given in S100 (the dancer roller 30 is outside the target range RG) and NO is given in S200 (the dancer roller 30 is not above the range upper limit RG1), NO is never given in S300. Accordingly, it may also be possible to provide a configuration in which, when the determination in S300 is omitted and NO is given in S200, the sequence flow advances directly to S310, and the rotation of the feeding portion 10 in the second direction D2 is started.

Thus, in the first control, the sequence flow advances to S210 or S310 and, before the pairs of rollers of the main conveying portion 12 and the sub-conveying portion 15 are rotationally driven, the feeding portion 10 is driven by the first drive unit to perform the position adjustment for the dancer roller 30. Specifically, by the driving of the feeding portion 10, control of moving the dancer roller 30 located outside the target range RG to the target position PS1 is performed. Then, after the position adjustment for the dancer roller 30 is performed (after the first control is performed), the second control is started to start the conveyance of the sheet 20a. In the first embodiment, it is determined whether to perform such first control or whether to perform the second control without performing the first control on the basis of a result of the detection by the roller position sensor 31 serving as the position detecting portion.

Note that, in a control example illustrated in FIG. 6, the description has been given only of the position control for the dancer roller 30 in the feeding section, but it may also be possible to provide a configuration in which position control for the dancer roller 40 in the winding section is also similarly performed in parallel. In other words, it may also be possible to provide a configuration in which, in the first control, the preliminary position adjustment for the dancer roller 40 is performed in the same manner as for the dancer roller 30. The position control for the dancer roller 40 is performed not by the feeding portion 10, but by controlling rotational driving of the winding portion 17. In other words, it may also be possible to provide a configuration in which position adjustment determination about whether or not the position control for the dancer roller 40 is necessary is made on the basis of a result of the sensing by the roller position sensor 41. When the dancer roller 40 is located above the range upper limit RG1, the winding portion 17 rotates in the third direction D3 to move the sheet 20a opposite to the conveyance direction Dc and thereby allow the dancer roller 40 to be lowered. Meanwhile, when the dancer roller 40 is located below the range lower limit RG2, the winding portion 17 rotates in the fourth direction D4 to move the sheet 20a in the conveyance direction Dc and thereby allow the dancer roller 40 to be lifted. With such a configuration, in the first control, it is possible to make preliminary adjustment so as to move the one of the dancer roller 30 and the dancer roller 40 that is located outside the target range to the target position.

The target ranges RG to be used for the position control for the dancer roller 30 and the dancer roller 40 need not necessarily be set the same, and it may also be possible to set different ranges and upper and lower limits. In addition, the position control for the dancer roller 30 and the position control for the dancer roller 40 may also be performed either in parallel or in order.

Thus, with the configuration in the first embodiment, before the feedback control, the dancer rollers 30 and 40 located outside the target ranges RG can be moved into the target ranges RG. Therefore, it is possible to prevent the top-out or bottom-out of the dancer rollers 30 and 40, which allows stable sheet conveyance to be performed, while preventing destabilized sheet conveyance and excessive tension. In addition, since the conveyance of the sheet 20a can be started without reducing the conveyance speed of the sheet 20a, it is possible to prevent the start of the sheet conveyance from being delayed.

### Second Embodiment

Next, a description will be given of the second embodiment according to the present disclosure. The second embodiment is different from the first embodiment in terms of a determination method for the position adjustment determination in S100 in FIG. 6. The following will describe only a point in a configuration of the second embodiment which is different from that in the configuration of the first embodiment. Components in the second embodiment which are the same as those in the first embodiment are denoted by the same reference signs, and a description thereof is omitted.

In the first embodiment, in S100 (position adjustment determination) of the conveyance start sequence, the determination is made on the basis of the position information of the dancer roller 30. Meanwhile, in the second embodiment, the determination of concern is made on the basis of the target speed, which is a target value of the conveyance speed at which the main conveying portion 12 and the sub-conveying portion 15 convey the sheet 20a. While the target speed is the target value of the rotation speeds of the pairs of rollers 12a and 15a included in the main conveying portion 12 and the sub-conveying portion 15, it may also be possible to use a moving speed of the sheet 20a conveyed by the pairs of rollers 12a and 15a as the target value. In other words, in the second embodiment, the conveyance control portion 207 determines that, when the target speed of the pairs of rollers 12a and 15a is not less than a predetermined threshold, the position adjustment is necessary. The following will describe the conveyance start sequence in the second embodiment with focus on a point different from that in the first embodiment.

In S100, the conveyance control portion 207 determines whether or not the position adjustment for the dancer roller 30 is necessary before the feedback control (S500) on the basis of the target speed of the main conveying portion 12 and the sub-conveying portion 15. Specifically, when the target speed is smaller than the predetermined threshold determined in advance, the conveyance control portion 207 determines that the position adjustment is unnecessary (NO in S100) and, when the target speed is not less than the predetermined threshold determined in advance, the conveyance control portion 207 determines that the position adjustment is necessary (YES in S100). The predetermined threshold can be determined according to, e.g., driving conditions during the sheet conveyance, such as a rotation speed of the feeding portion 10 set in advance, or a configuration of a sheet conveyance path. Note that, in the second embodiment, determining that the position adjustment is necessary in S100 does not necessarily mean that preliminary position adjustment is performed for the dancer roller 30. When it is determined that the position adjustment is necessary in S100, it is determined once again thereafter whether or not the position adjustment is necessary on the basis of the position information of the dancer roller 30. In other words, even when YES is given in S100, there is a possibility that the preliminary position adjustment for the dancer roller 30 may not be performed.

When NO is given in S100, the sequence flow moves to S500 where the feedback control for adjusting the position of the dancer roller 30, while conveying the sheet, is started, and then the main conveying portion 12 and the sub-conveying portion 15 are driven to start conveying the sheet. At this time, the target speed of the main conveying portion 12 and the sub-conveying portion 15 is lower than the predetermined threshold and is sufficiently low compared to the rotation speed of the feeding portion 10. Therefore, even when the main conveying portion 12 and the sub-conveying portion 15 start conveying the sheet in a state where the dancer roller 30 is located outside the target range RG, the position of the dancer roller 30 is adjusted by the feedback control, and therefore a possibility that the top-out or bottom-out may occur is low.

When YES is given in S100, the sequence flow moves to S200 where the determination based on the position information of the dancer roller 30 is made. In a case where the target speed is not less than the predetermined threshold, when the sheet conveyance is started in a state where the dancer roller 30 is located outside the target range RG, even though the feedback control is performed, a possibility that the top-out or bottom-out may occur increases. Accordingly, when the target speed is not less than the predetermined threshold, the determination about the position of the dancer roller 30 is made in S200 or S300, and the position adjustment for the dancer roller 30 is performed as necessary. In other words, in the second embodiment, when the target speed of the main conveying portion 12 and the sub-conveying portion 15 is not less than the predetermined threshold, it is determined whether to perform the first control or whether to perform the second control on the basis of the result of the detection by the roller position sensor 31.

Note that, in the example described above, the position adjustment determination is made on the basis of the target speed of the main conveying portion 12 and the sub-conveying portion 15, but the position adjustment determination is not limited to such a configuration. For example, instead of the target speed, an acceleration until the target speed is reached when the rotation of the pairs of rollers 12a and 15a of the main conveying portion 12 and the sub-conveying portion 15 is started may also be used. When the acceleration is sufficiently low, even though the sheet conveyance is started in a state where the dancer roller 30 is located outside the target range RG, the position of the dancer roller 30 is adjusted by the feedback control, and accordingly the possibility that the top-out or bottom-out may occur is low. In other words, in the second embodiment, the conveyance control portion 207 may also be configured so as to determine that the position adjustment is necessary when the acceleration until the target speed of the pairs of rollers 12a and 15a is reached is not less than the predetermined threshold.

Thus, with the configuration of the second embodiment, it is possible to make the position adjustment determination about whether or not the position adjustment for the dancer roller 30 is necessary on the basis of the driving conditions for the main conveying portion 12 and the sub-conveying portion 15 during the sheet conveyance. In addition, in the present example also, it is possible to perform the position control for the dancer roller 40 in the same manner as for the dancer roller 30. In other words, before the feedback control, the dancer rollers 30 and 40 located outside the target range RG can be moved into the target range RG. Therefore, it is possible to prevent the top-out or bottom-out of the dancer rollers 30 and 40, which allows stable sheet conveyance to be performed, while preventing destabilized sheet conveyance and excessive tension. In addition, since the conveyance of the sheet 20a can be started without reducing the conveyance speed of the sheet 20a, it is possible to prevent the start of the sheet conveyance from being delayed.

### Third Embodiment

Next, a description will be given of the third embodiment according to the present disclosure. The third embodiment is different from the first embodiment in terms of a determination method for the position adjustment determination in S100 in FIG. 6. The following will describe only a point in a configuration of the third embodiment which is different from that in the configuration of the first embodiment. Components in the third embodiment which are the same as those in the first embodiment are denoted by the same reference signs, and a description thereof is omitted.

The recording apparatus 90 according to the third embodiment further includes a replacement sensing portion that senses replacement of the roll sheet 20 in the feeding portion 10. The replacement sensing portion can be provided in, e.g., an attachment portion of the feeding portion 10 for the roll sheet 20, and a known sensor capable of sensing attachment or detachment of the roll sheet 20 to or from a bearing or the presence or absence of the roll sheet 20 in the feeding portion 10 or the like can be used.

The replacement of the roll sheet 20 is performed by a manual operation by the user and, after the replacement, the tension received by the dancer roller 30 from the sheet 20a is difficult to be constant, and the position of the dancer roller 30 is also unstable. Accordingly, in the third embodiment, a configuration is provided in which, in the sheet conveyance start sequence immediately after the replacement of the roll sheet 20, preliminary position adjustment is performed for the dancer roller 30, and then the sheet conveyance is started.

In the first embodiment, in S100 (position adjustment determination) of the conveyance start sequence, the determination is made on the basis of the position information of the dancer roller 30. Meanwhile, in the third embodiment, the determination is made on the basis of a result of the sensing by the replacement sensing portion. In other words, in the third embodiment, the conveyance control portion 207 determines that the position adjustment is necessary when the replacement of the roll sheet 20 is sensed by the replacement sensing portion. The following will describe the conveyance start sequence in the third embodiment with focus on a point different from that in the first embodiment.

In S100, the conveyance control portion 207 determines whether or not the position adjustment for the dancer roller 30 is necessary before the feedback control (S500) on the basis of the result of the sensing by the replacement sensing portion. Specifically, when the replacement of the roll sheet 20 performed in the feeding portion 10 after a final stop of the sheet conveyance is not sensed by the replacement sensing portion, the conveyance control portion 207 determines that the position adjustment is unnecessary (NO in S100). Meanwhile, when the replacement of the roll sheet 20 performed in the feeding portion 10 after the final stop of the sheet conveyance is sensed by the replacement sensing portion, the conveyance control portion 207 determines that the position adjustment is necessary (YES in S100). Note that, in the third embodiment, determining that the position adjustment is necessary in S100 does not necessarily mean that preliminary position adjustment is performed for the dancer roller 30. When it is determined that the position adjustment is necessary in S100, it is determined once again thereafter whether or not the position adjustment is necessary on the basis of the position information of the dancer roller 30. In other words, even when YES is given in S100, there is a possibility that the preliminary position adjustment for the dancer roller 30 may not be performed.

When NO is given in S100, the sequence flow moves to S500 where the feedback control for adjusting the position of the dancer roller 30, while conveying the sheet, is started, and then the main conveying portion 12 and the sub-conveying portion 15 are driven to start conveying the sheet. At this time, the roll sheet 20 has not been replaced since the immediately previous sheet conveyance, and accordingly a possibility that the dancer roller 30 may be located outside the target range RG is lower than in a case where the roll sheet 20 has been replaced. Therefore, even when the main conveying portion 12 and the sub-conveying portion 15 start conveying the sheet without the preliminary position adjustment for the dancer roller 30, the position of the dancer roller 30 is adjusted by the feedback control, and a possibility that the top-out or bottom-out may occur is low.

When YES is given in S100, the sequence flow moves to S200 where the determination based on the position information of the dancer roller 30 is made. In a case where the roll sheet 20 was replaced immediately before, the dancer roller 30 may be located outside the target range RG and, when the sheet conveyance is started, there is a possibility that the top-out or bottom-out may occur. Accordingly, the determination about the position of the dancer roller 30 is made in S200 or S300, and the position adjustment for the dancer roller 30 is performed as necessary. In other words, in the third embodiment, when the replacement of the roll sheet 20 is sensed by the replacement sensing portion, whether to perform the first control or whether to perform the second control is determined on the basis of the result of the detection by the roller position sensor 31.

Thus, with the configuration of the third embodiment, it is possible to make the position adjustment determination about whether or not the position adjustment for the dancer roller 30 is necessary on the basis of information on the replacement of the roll sheet 20 in the feeding portion 10. In addition, in the present example also, by providing the winding portion 17 with the replacement sensing portion, it is possible to perform the position control for the dancer roller 40 in the same manner as for the dancer roller 30. In other words, before the feedback control, the dancer rollers 30 and 40 located outside the target range RG can be moved into the target range RG. Therefore, it is possible to prevent the top-out or bottom-out of the dancer rollers 30 and 40, which allows stable sheet conveyance to be performed, while preventing destabilized sheet conveyance and excessive tension. In addition, since the conveyance of the sheet 20a can be started without reducing the conveyance speed of the sheet 20a, it is possible to prevent the start of the sheet conveyance from being delayed.

### OTHER EMBODIMENTS

Note that the method of the position adjustment determination for the dancer roller in the sheet conveyance start sequence is not limited to those mentioned in the individual embodiments described above. For example, a consideration will be given to a configuration in which the recording apparatus 90 is provided with an operation portion such as a conveyance start button to be operated by the user to be able to start the conveyance of the sheet 20a. In such a configuration, when the user operates the operation portion to start the conveyance of the sheet (start the sheet conveyance start sequence), it may be determined in the position adjustment determination (S100 in FIG. 6) that the position adjustment for the dancer roller 30 is necessary.

Additionally, in each of the embodiments described above, in the sheet conveyance start sequence, the position adjustment determination and the position adjusting operation have been performed, but are not limited to such a configuration. As long as the sheet 20a is in a state nipped between the unrotating pairs of rollers 12a and 15a, the position adjustment determination and the position adjusting operation for the dancer roller can be performed with any given timing.

In applying the present disclosure, the processing described as being performed by one device in each of the embodiments may also be shared and performed by a plurality of devices. Alternatively, the processing as described as being performed by different devices may also be performed by one device. In a computer system, which hardware configuration is used to implement each function can flexibly be changed.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-141976, filed Aug. 23, 2024, which is hereby incorporated by reference herein in its entirety.

What is claimed is:

1. A sheet conveying device comprising:
a holding portion configured to hold a roll sheet in which a sheet is wound;
a first drive unit configured to rotate the roll sheet held by the holding portion in a first direction and in a second direction opposite to the first direction;
a pair of rollers configured to hold the sheet continued from the roll sheet held by the holding portion therebetween;
a second drive unit configured to rotationally drives the pair of rollers;
a dancer roller configured to come into contact with the sheet, the dancer roller provided between the holding portion and the pair of rollers in a conveyance direction of the sheet and being configured to be linearly movable in a movement direction crossing the conveyance direction;
a position detecting portion configured to detect a position of the dancer roller in the movement direction; and
a control portion configured to perform (i) first control of using the first drive unit to adjust the position of the dancer roller on the basis of a result of a detection by the position detecting portion before using the second drive unit to start the conveyance of the sheet and (ii) second control of using the second drive unit to start the conveyance of the sheet without performing the first control.

2. The sheet conveying device according to claim 1,
wherein the control portion is configured to be able to make position adjustment determination about whether or not position adjustment for the dancer roller is necessary, and determines whether to perform the first control or whether to perform the second control on the basis of a determination result of the position adjustment determination.

3. The sheet conveying device according to claim 1,
wherein the first control includes control of moving the position of the dancer roller located outside a predetermined target range to a predetermined target position, and
wherein the second control includes control of keeping the position of the dancer roller within the predetermined target range.

4. The sheet conveying device according to claim 1,
wherein, in the first control, the control portion controls the second drive unit such that the pair of rollers stop rotating.

5. The sheet conveying device according to claim 1,
wherein, in the second control, the control portion uses the first drive unit to rotationally drive the roll sheet held by the holding portion, while using the second drive unit to rotationally drive the pair of rollers.

6. The sheet conveying device according to claim 1,
wherein the control portion starts the second control after performing the first control.

7. The sheet conveying device according to claim 1,
wherein the control portion performs the first control in a case where the dancer roller is apart by a predetermined distance or longer from a predetermined reference position.

8. The sheet conveying device according to claim 1,
wherein, in a case where a target value of a conveyance speed at which the pair of rollers convey the sheet is not less than a predetermined threshold, the control portion determines whether to perform the first control or whether to perform the second control on the basis of a result of the detection.

9. The sheet conveying device according to claim 1,
wherein, in a case where an acceleration until a conveyance speed at which the pair of rollers convey the sheet reaches a target value is not less than a predetermined threshold, the control portion determines whether to perform the first control or whether to perform the second control on the basis of a result of the detection.

10. The sheet conveying device according to claim 1, further comprising:
a replacement sensing portion configured to sense replacement of the roll sheet in the holding portion,
wherein, in a case where the replacement of the roll sheet is sensed by the replacement sensing portion, the control portion determines whether to perform the first control or whether to perform the second control on the basis of a result of the detection.

11. The sheet conveying device according to claim 1, further comprising:
an operation portion for driving the pair of rollers to start the conveyance of the sheet,
wherein, in a case where a user operates the operation portion to start the conveyance of the sheet, the control portion determines whether to perform the first control or whether to perform the second control on the basis of a result of the detection.

12. The sheet conveying device according to claim 1,
wherein the control portion performs a position adjustment for the dancer roller by rotating the roll sheet held by the holding portion in a state where the sheet is nipped between the pair of rollers.

13. The sheet conveying device according to claim 1, further comprising:
a defining member configured to define a movable range of the dancer roller in the movement direction.

14. A recording apparatus comprising:
a sheet conveying device, the sheet conveying device including:
a holding portion configured to hold a roll sheet in which the sheet is wound;
a first drive unit configured to rotate the roll sheet held by the holding portion in a first direction and in a second direction opposite to the first direction;
a pair of rollers configured to hold the sheet continued from the roll sheet held by the holding portion therebetween;
a second drive unit configured to rotationally drives the pair of rollers;
a dancer roller configured to come into contact with the sheet, the dancer roller provided between the holding portion and the pair of rollers in a conveyance direction of the sheet and being configured to be linearly movable in a movement direction crossing the conveyance direction;
a position detecting portion configured to detect a position of the dancer roller in the movement direction; and
a control portion configured to perform (i) first control of using the first drive unit to adjust the position of the dancer roller on the basis of a result of a detection by the position detecting portion before using the second drive unit to start the conveyance of the sheet and (ii) second control of using the second drive unit to start the conveyance of the sheet without performing the first control; and
a recording portion configured to record an image on the sheet conveyed by the sheet conveying device.

15. The recording apparatus according to claim 14,
wherein the holding portion is a feeding portion configured to feed the sheet toward the recording portion.

16. The recording apparatus according to claim 14,
wherein the holding portion is a winding portion configured to wind up the sheet with the image recorded thereon in the recording portion.

17. The recording apparatus according to claim 14, further comprising, in a case where it is assumed that the holding portion is a first holding portion, the pair of rollers is a first pair of rollers, the dancer roller is a first dancer roller, and the position detecting portion is a first position detecting portion:
a second holding portion provided opposite to the first holding portion with respect to the recording portion in the conveyance direction;
a third drive unit configured to rotate the roll sheet held by the second holding portion in a third direction and in a fourth direction opposite to the third direction;
a second pair of rollers configured to hold the sheet therebetween between the recording portion and the second holding portion in the conveyance direction;
a fourth drive unit configured to rotationally drives the second pair of rollers;
a second dancer roller configured to come into contact with the sheet, the second dancer roller provided between the second holding portion and the second pair of rollers in the conveyance direction and being configured to be linearly movable in the movement direction crossing the conveyance direction; and
a second position detecting portion that detects a position of the second dancer roller in the movement direction,
wherein, in the first control, the control portion uses the third drive unit to adjust the position of the second dancer roller before using the third drive unit to start the conveyance of the sheet.
